(19) United States
(12) Patent Application Publication
(10) Pub. No.: US 2019/0146425 A1
(43) Pub. Date: May 16, 2019

(54) METHOD AND APPARATUS FOR CONTROLLING DEMAND MANAGEMENT BASED ON ENERGY SOURCE SELECTION BY REAL-TIME PRICE INFORMATION

(71) Applicant: ELECTRONICS AND TELECOMMUNICATIONS RESEARCH INSTITUTE, Daejeon (KR)

(72) Inventor: Seok-jin LEE, Daejeon (KR)

(21) Appl. No.: 16/176,394

(22) Filed: Oct. 31, 2018

(30) Foreign Application Priority Data
Nov. 15, 2017 (KR) 10-2017-0152462
Sep. 20, 2018 (KR) 10-2018-0112940

(51) Int. Cl. G05B 13/02; G06Q 50/06

(52) U.S. Cl. CPC G05B 13/026; G06Q 50/06

(57) ABSTRACT

A method and apparatus for controlling a demand management based on an energy source selection by real-time price information. The method of controlling a demand management includes determining a lowest price energy source from among a plurality of energy sources based on energy price information associated with the plurality of energy sources and a level of a consumption need of a user for an energy use; and controlling an energy consumption apparatus to be supplied with energy from the determined energy source and to consume the supplied energy.

### CROSS-REFERENCE TO RELATED APPLICATION(S)

This application claims the priority benefit of Korean Patent Application No. 10-2017-0152462 filed on Nov. 15, 2017 and Korean Patent Application No. 10-2018-0112940 filed on Sep. 20, 2018 in the Korean Intellectual Property Office, the disclosures of which are incorporated herein by reference for all purposes.

### BACKGROUND

### 1. Field of the Invention

One or more example embodiments relate to a method and apparatus for economically controlling an energy apparatus by selecting an appropriate energy source in an economical aspect.

### 2. Description of Related Art

In terms of electricity, short supply or oversupply should not occur.

To meet the electricity demand in real time, an electric power supplier has been equipped with various types of large facilities and coped with fluctuations in real time, which is one of the reasons for a rise in electricity supply unit price. Any method capable of inducing such demand to the available supply range may be a good solution that may lead to reducing electric charges through reduction in facility cost of the electric power supplier.

Therefore, electricity charges may be evaluated to be high at a peak time and to be low at a time in which the electric power remains. As a policy to compensate for a decrease in electricity consumption during the late night, there is a late-night charge policy in which relatively low price is set to the surplus power of the late night.

A gas boiler according to the related art may use gas as a main energy source and may use electricity preliminarily in the case in which the gas supply is insufficient. To select a low cost energy source in real time and realize the minimum energy cost, a time in which a unit price of power is low needs to be known.

To meet such a demand, a structure for using late night power at a low cost by installing a clock in an apparatus and by setting a control apparatus to a time value notified in advance may be employed.

Currently, a late-night charge plan operation method generally uses a fixed time system that notifies in advance a time zone in which a late-night charge plan is applied and sets the time zone in the apparatus. For example, a time switch may be set and used. Here, a clock may use, for example, a frequency, a mechanical scheme, a global positioning system (GPS) signal, and a mobile communication system.

Here, a time zone in which electricity consumption is estimated to decrease may be predetermined and an amount of power used during the time zone may be measured. This method may not sufficiently cope with an environment in which demand and supply of electricity change frequently in real time.

### SUMMARY

At least one example embodiment provides technology that may be differentiated from a fixed time scheme, for example, a time-of-use (TOU) scheme and a critical peak pricing (CPP) scheme, of notifying an energy unit price for each time zone in advance, and may allow a user to apply unit price information for an energy use through, for example, a real-time pricing (RTP) scheme and a scheme of providing changing charges to the user, and accordingly enables the user to use energy at relatively low price.

According to an aspect of at least one example embodiment, there is provided a method of controlling a demand management, the method including determining a lowest price energy source from among a plurality of energy sources based on energy price information associated with the plurality of energy sources and a level of a consumption need of a user for an energy use; and controlling an energy consumption apparatus to be supplied with energy from the determined energy source and to consume the supplied energy.

The demand management control method may further include acquiring the level of the consumption need of the user for the energy use in response to an energy consumption demand.

The demand management control method may further include determining a current temperature and a setting temperature of the energy consumption apparatus, and determining whether the energy consumption demand occurs.

The determining may include evaluating an energy consumption demand value based on the consumption need of the user for the energy use in response to an energy consumption demand; and selecting the energy source corresponding to the energy consumption demand value based on the energy price information.

The selecting may include maintaining an initial setting temperature of the energy consumption apparatus and selecting the lowest price energy source in response to the energy consumption demand value being evaluated to maintain the energy consumption demand; and resetting the initial setting temperature and selecting the lowest price energy source in response to the energy consumption demand value being evaluated to adjust the energy consumption demand for energy saving.

The resetting and the selecting may include resetting the initial setting temperature by applying a difference between an average energy price of a previous day and a real-time energy price (RTP) included in the energy price information; and selecting the lowest price energy source based on the reset temperature and the energy price information.

The resetting and the selecting may further include comparing the reset temperature and a current temperature of the energy consumption apparatus and holding the energy use.

The resetting may include setting a weight for resetting the initial setting temperature based on at least one of a number of times an energy use emergency button corresponding to the consumption need of the user is pressed and feedback of the user.

According to an aspect of at least one example embodiment, there is provided a consumer energy apparatus including a demand management control apparatus configured to determine a lowest price energy source from among a plurality of energy sources based on energy price information associated with the plurality of energy sources and a level of a consumption need of a user for an energy use; and an energy consumption apparatus configured to be supplied with energy from the determined energy source and to consume the supplied energy under control of the demand management control apparatus.

The demand management apparatus may include a communication module configured to receive the energy price information; and a processor configured to evaluate an energy consumption demand value based on the consumption need of the user for the energy use in response to an energy consumption demand, and to select the energy source corresponding to the energy consumption demand value based on the energy price information.

The processor may be configured to acquire the level of the consumption need of the user for the energy use in response to an energy consumption demand.

The processor may be configured to determine a current temperature and a setting temperature of the energy consumption apparatus, and to determine whether the energy consumption demand occurs.

The processor may be configured to maintain an initial setting temperature of the energy consumption apparatus and select the lowest price energy source in response to the energy consumption demand value being evaluated to maintain the energy consumption demand, and to reset the initial setting temperature and select the lowest price energy source in response to the energy consumption demand value being evaluated to adjust the energy consumption demand for energy saving.

The processor is configured to reset the initial setting temperature by applying a difference between an average energy price of a previous day and a real-time energy price (RTP) included in the energy price information, and to select the lowest price energy source based on the reset temperature and the energy price information.

The processor may be configured to compare the reset temperature and a current temperature of the energy consumption apparatus and hold the energy use.

The processor may be configured to set a weight for resetting the initial setting temperature based on at least one of a number of times an energy use emergency button corresponding to the consumption need of the user is pressed and feedback of the user.

The demand management control apparatus may further include a user interface module configured to set a temperature of the energy consumption apparatus in response to an input of the user.

The user interface module may include an energy use emergency button corresponding to the consumption need of the user configured to maintain the energy consumption demand.

The user interface module may further include a price application button configured to corresponding to the consumption need of the user configured to adjust the energy consumption demand for energy saving.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating an example of an energy management system according to an example embodiment;

FIG. 2 is a diagram illustrating an example of a consumer energy apparatus of FIG. 1 according to an example embodiment;

FIG. 3 is a diagram illustrating an example of a demand management control apparatus of FIG. 2 according to an example embodiment;

FIG. 4 is a diagram illustrating an example of an energy consumption apparatus of FIG. 2 according to an example embodiment;

FIG. 5 is a flowchart illustrating an example of a method of selecting an energy source in an energy consumption apparatus according to an example embodiment;

FIG. 6 is a flowchart illustrating an example of a method of selecting an energy source based on a result of evaluating an energy consumption demand value according to an example embodiment; and

FIG. 7 illustrates an example of a user interface module of FIG. 3 according to an example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

The following detailed structural or functional description of example embodiments is provided as an example only and various alterations and modifications may be made to the example embodiments. Accordingly, the example embodiments are not construed as being limited to the disclosure and should be understood to include all changes, equivalents, and replacements within the technical scope of the disclosure.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

The term “module” used herein may refer to hardware that may perform functions and operations according to the respective names described herein and may indicate a computer program code that may perform a specific function and operation. Alternatively, the module may refer to a non-transitory computer-readable recording medium, for example, a processor or a microprocessor in which the computer program code capable of performing the specific function and operation is included.

That is, the term “module” may indicate a functional and/or structural combination of hardware for performing the technical spirit of the disclosure and/or software for driving such hardware.

The following example embodiments may be differentiated from a fixed time scheme of notifying an energy unit price for each time zone in advance, and may allow a user to apply unit price information for an energy use, and accordingly enables the user to use energy at relatively low price.

An energy supplier may induce real-time adjustment of energy demand through participation of a consumer and may reduce cost of peak energy supply facility.

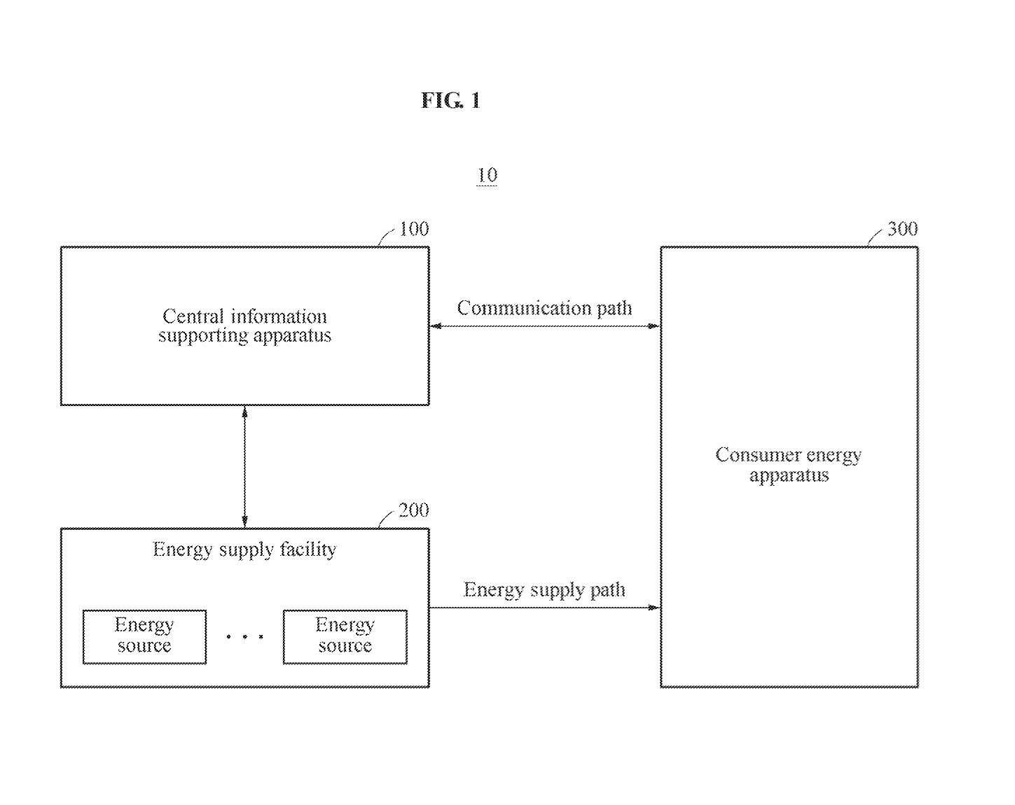

FIG. 1 is a diagram illustrating an example of a boiler apparatus according to an example embodiment.

Referring to FIG. 1, an energy management system 10 performs a method of controlling a demand management in response to a selection of an energy source based on real-time price information. The energy management system 10 includes a central information supporting apparatus 100, an energy supply facility 200, and a consumer energy apparatus 300.

The central information supporting apparatus 100 may communicate with the consumer energy apparatus 300. For example, communication may be performed through a wired communication method and/or a wireless communication method. The wired communication method may include Ethernet, optical Ethernet, a dedicated wired network, etc., using a power line communication (PLC) or a wired communication cable. The wireless communication method may include a real-time frequency modulation (FM) broadcasting, mobile communication, for example, code division multiple access (CDMA) and long-term evolution (LTE), mobile communication node base-Internet of things (NB-IoT), wireless IoT, for example, LoRa and ZigBee, and other dedicated communication networks.

The central information supporting apparatus 100 may regularly support the consumer energy apparatus 300 to enable clock synchronization within the consumer energy apparatus 300. That is, the central information supporting apparatus 100 may regularly transmit information for control time synchronization of the consumer energy apparatus 300 to the consumer energy apparatus 300 through wired and/or wireless communication.

Also, the central information supporting apparatus 100 may provide energy price information to the consumer energy apparatus 300 through communication. The central information supporting apparatus 100 may transmit the energy price information to the consumer energy apparatus 300 through broadcasting or group communication. For example, the energy price information may include power unit price information for each time zone of each energy source included in the energy supply facility 200.

That is, the central information supporting apparatus 100 may refer to a server apparatus configured to provide real-time charge information of energy price.

The energy supply facility 200 may include a plurality of energy sources. The energy supply facility 200 may transfer energy to the consumer energy apparatus 300 using an energy source selected from among the plurality of energy sources. For example, the plurality of energy sources may include gas and electricity.

The energy supply facility 200 may transmit energy price information of each of the plurality of energy sources to the central information supporting apparatus 100. For example, the energy price information may include power unit price information for each real-time time zone of each energy source.

Although FIG. 1 illustrates the energy supply facility 200 as a single facility including the plurality of energy sources, it is provided as an example only. Depending on example embodiments, each of the plurality of energy sources may be configured as a single independent energy supply facility.

The consumer energy apparatus 300 may receive, from the central information supporting apparatus 100, energy price information, for example, power unit price information for each time zone of each of the energy sources included in the energy supply facility 200. The consumer energy apparatus 300 may compare energy supply unit prices of the respective energy sources based on the power unit price information and may select a low price optimal energy source from among the plurality of energy sources and may determine a supply.

In the case of a gas supply, an energy unit price may not fluctuate. On the contrary, in the case of an electricity supply, an energy unit price may vary several times even during a day. Accordingly, a meaning of the RTP may be significant. Accordingly, selecting the low price optimal energy source may lead to achieving the low cost for energy use.

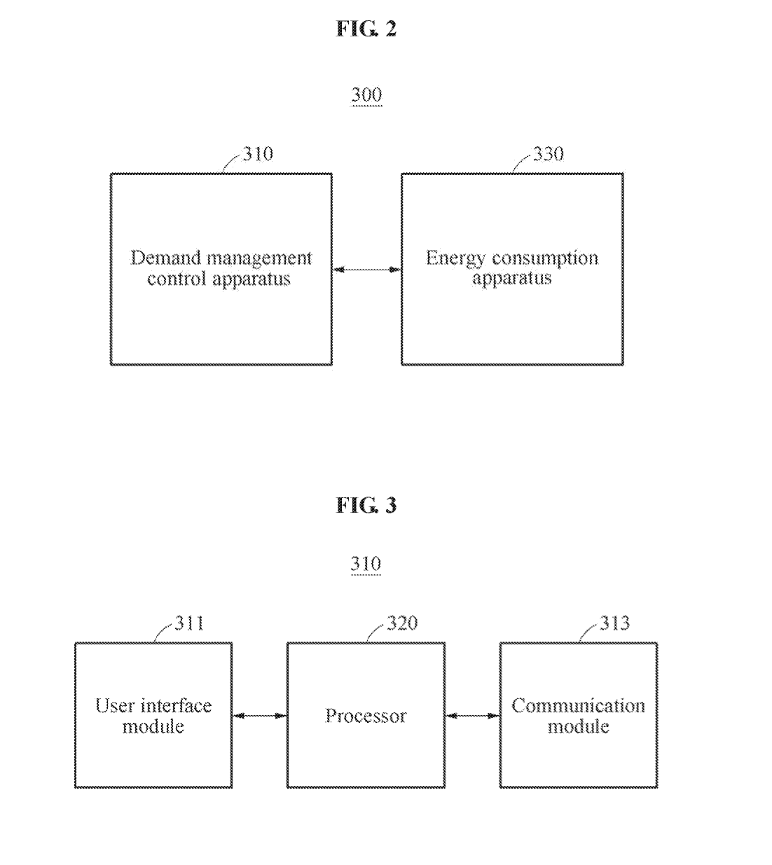

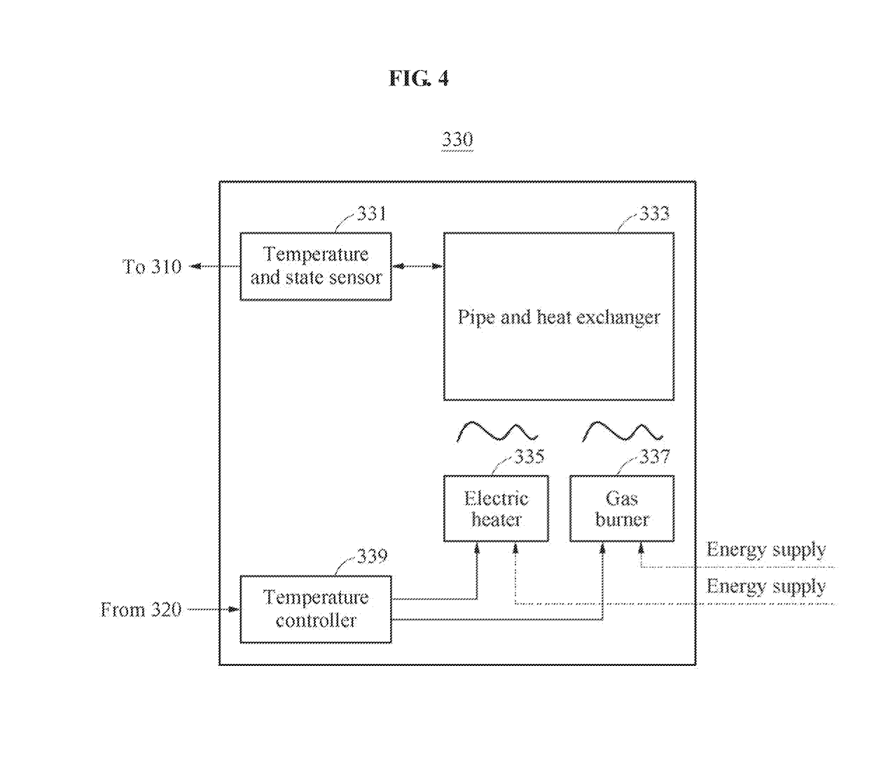

FIG. 2 is a diagram illustrating an example of a consumer energy apparatus of FIG. 1 according to an example embodiment, FIG. 3 is a diagram illustrating an example of a demand management control apparatus of FIG. 2 according to an example embodiment, and FIG. 4 is a diagram illustrating an example of an energy consumption apparatus of FIG. 2 according to an example embodiment.

Referring to FIGS. 2 through 4, the consumer energy apparatus 300 includes a demand management control apparatus 310 and an energy consumption apparatus 330.

In response to an energy demand, the demand management control apparatus 310 may select an energy source to be currently used based on emergency of the energy demand and real-time price information of each energy source, and may control the energy consumption apparatus 330 to be supplied with energy from the selected energy source and to consume energy.

The demand management control apparatus 310 may receive real-time price information from the central information supporting apparatus 100 through communication with an outside to reduce spending used to select a thermal energy source to be currently used.

Referring to FIG. 3, the demand management control apparatus 310 includes a user interface module 311, a communication module 313, and a processor 320.

The user interface module 311 may set a temperature or a temperature value of the energy consumption apparatus 330 in response to a user input, for example, an input of a setting temperature, and may display the setting temperature. The setting temperature may indicate a desired temperature indoors.

The user interface module 311 may receive sensing data from a temperature and state sensor 331 included in the energy consumption apparatus 330. The user interface module 311 may display a current state and/or a current temperature or a current temperature value of the energy consumption apparatus 330 based on the sensing data.

The communication module 313 may receive energy price information from the central information supporting apparatus 100. The communication module 313 may transmit the energy price information to the processor 320.

The processor 320 may include at least one core. The processor 320 may control the overall operation of the demand management control apparatus 310. For example, the processor 320 may control an operation of each configuration, for example, the user interface module 311 and the communication module 313, of the demand management control apparatus 310. Also, the processor 320 may control the overall operation of the energy consumption apparatus 330.

The processor 320 may determine whether an energy consumption demand occurs. For example, the processor 320 may compare a current temperature and a setting temperature of the energy consumption apparatus 330 and may determine whether the energy consumption demand occurs.

In response to the occurrence of the energy consumption demand, the processor 320 may acquire a level of a consumption need of the user for energy use, and may select an optimal energy source from among the plurality of energy sources based on the level of the consumption need of the user and the energy price information. Here, the level of the consumption need of the user may be, for example, an emergency level of an energy consumption need of the user, and the energy use may be, for example, the energy consumption demand.

Here, the processor 320 may evaluate an energy consumption demand value based on the level of the consumption need for the energy use and may select the energy source corresponding to the evaluation of the energy consumption demand value based on the energy price information.

The level of the consumption need of the user for the energy use may be determined based on whether an energy use emergency button is pressed. Also, the level of the consumption need of the user for the energy use may be determined by considering a safety status of the energy consumption apparatus 330 based on a setting value determined by the user.

For example, if the user is in an urgent need for the energy use, the processor 320 may evaluate the energy consumption demand value to maintain the energy consumption demand. Here, maintaining the energy consumption demand may indicate consuming the energy while maintaining a setting temperature as is without resetting the setting temperature. That is, maintaining the energy consumption demand may indicate absolutely maintaining the energy consumption demand.

In response to the occurrence of the energy consumption demand, the processor 320 may determine a lowest price energy source from among the plurality of energy sources based on the energy price information.

As another example, if the user is not in an urgent need for the energy consumption demand, the processor 320 may evaluate the energy consumption demand value to adjust the energy consumption demand for energy saving. The energy saving may indicate reducing the energy consumption, that is, consuming the energy while saving the energy by resetting the setting temperature.

Here, the processor 320 may reset the setting temperature by applying the energy price information. A weight for resetting the setting temperature may be determined based on at least one of a number of times a corresponding button is pressed and feedback of the user, for example, comments after use. The processor 320 may determine again whether to use the energy, for example, the energy consumption demand, based on the reset temperature and the current temperature, and may determine the lowest price energy source from among the plurality of energy sources based on the energy price information.

If the user is not in the urgent need for the energy consumption demand, the processor 320 may compare the reset temperature and the current temperature and may hold the energy use or energy supply. If the energy consumption apparatus 330 is a heating apparatus, the processor 320 may hold the energy use when the reset temperature is lower than the current temperature. If the energy consumption apparatus 330 is a cooling apparatus, the processor 320 may hold the energy use when the reset temperature is higher than the current temperature.

As described above, the processor 320 may control the energy consumption through various selections, for example, selecting the low price energy source, holding the energy use, over the energy consumption demand value.

The processor 320 may control a temperature controller of the energy consumption apparatus 330 so that the energy consumption apparatus 330 may be supplied with the energy from the selected energy source and may consume the energy.

The energy consumption apparatus 330 may increase or decrease a temperature by using or consuming the energy with the energy being supplied. Also, the energy consumption apparatus 330 may be supplied with the energy from the selected energy source under control of the demand management control apparatus 310 and may use the energy. The energy consumption apparatus 330 may be a heating apparatus and/or a cooling apparatus.

Referring to FIG. 4, the energy consumption apparatus 330 may include the temperature and state sensor 331, a pipe and heat exchanger 333, a heat source for electricity, for example, an electric heater, 335, a heat source for gas, for example, a gas burner, 337, and a temperature controller 339.

The temperature and state sensor 331 may sense a temperature and/or a state of the energy consumption apparatus 330. For example, the temperature and/or the state of the energy consumption apparatus 330 may indicate a temperature and/or a state of the pipe and heat exchanger 333.

The pipe and heat exchanger 333 may provide heating or cooling around the energy consumption apparatus 330 through the heat source for electricity 335 and/or the heat source for gas 337.

The temperature controller 339 may control an operation of the heat source for electricity 335 and/or the heat source for gas 337 so that the pipe and heat exchanger 333 may be supplied with the energy through the heat source for electricity 335 and/or the heat source for gas 337.

Also, the temperature controller 339 may control an operation of the heat source for electricity 335 and/or the heat source for gas 337 corresponding to the selected energy source under control of the processor 320. For example, if the processor 320 selects an electric energy source, the temperature controller 339 may control the operation of the heat source for electricity 335 so that the energy may be supplied to the pipe and heat exchanger 333 through the heat source for electricity 335. If the processor 320 selects a gas energy source, the temperature controller 339 may control the operation of the heat source for gas 337 so that the energy may be supplied to the pipe and heat exchanger 333 through the heat source for gas 337.

That is, the temperature controller 339 may control the pipe and heat exchanger 333 to heat or cool around using the energy that is transferred through a lowest price energy source in real time.

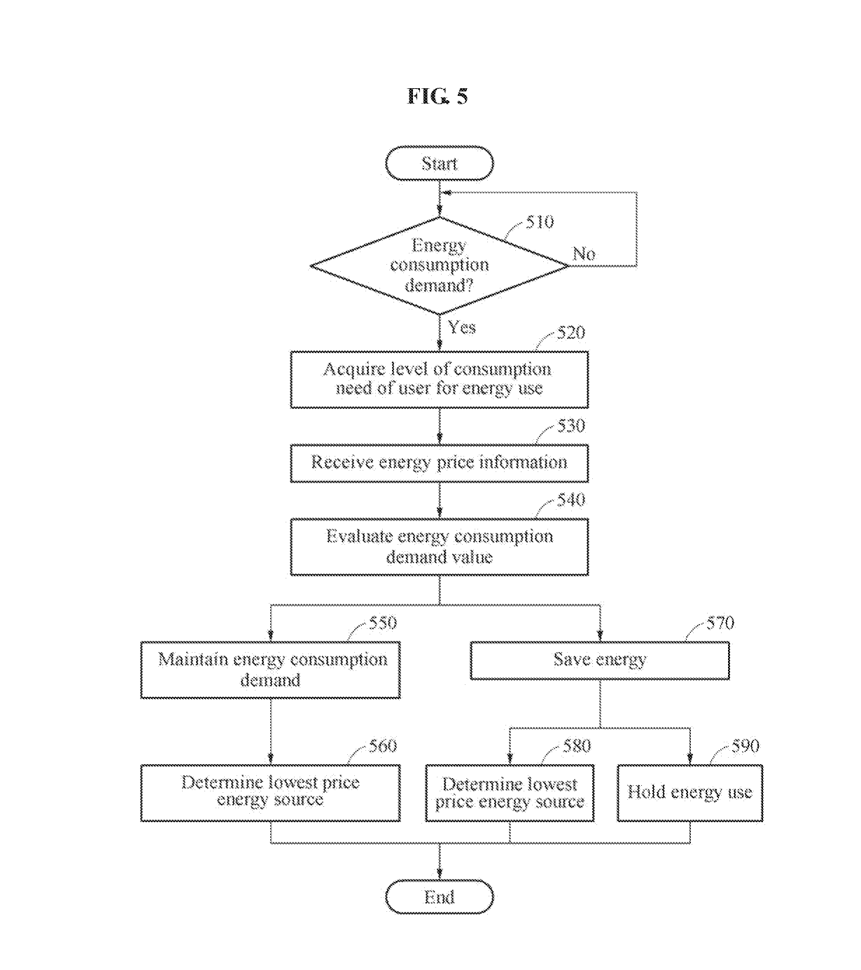

FIG. 5 is a flowchart illustrating an example of a method of selecting an energy source in an energy consumption apparatus according to an example embodiment.

Referring to FIG. 5, in operation 510, the processor 320 may determine whether an energy consumption demand occurs.

The processor 320 may compare a current temperature and a setting temperature of the energy consumption apparatus 330 and may determine whether the energy consumption demand occurs. For example, if the energy consumption apparatus 330 is a heating apparatus, the processor 320 may determine that the energy consumption demand occurs when the setting temperature is higher than the current temperature. If the energy consumption apparatus 330 is a cooling apparatus, the processor 320 may determine that the energy consumption demand occurs when the setting temperature is lower than the current temperature. The energy consumption demand may indicate a demand, for example, a request, of the user for energy consumption.

In operation 520, the processor 320 may acquire a level of a consumption need of the user for energy use in response to the occurrence of the energy consumption demand.

In operation 530, the processor 320 may receive energy price information from the central information supporting apparatus 100 in response to the occurrence of the energy consumption demand. For example, the energy price information may include power unit price information for each real-time time zone of each energy source.

In operation 540, the processor 320 may evaluate an energy consumption demand value based on the level of the consumption need of the user for the energy use.

If the user is in an urgent need for the energy use, the processor 320 may evaluate the energy consumption demand value such to maintain the energy consumption demand in operation 550. In operation 560, the processor 320 may determine a lowest price energy source from among the plurality of energy sources based on the energy price information.

If the user is not in the urgent need for the energy consumption demand, the processor 320 may evaluate the energy consumption demand value to adjust the energy consumption demand for energy saving in operation 570. In operation 580, the processor 320 may determine the lowest price energy source from among the plurality of energy sources based on a reset temperature to which the energy price information is applied. In operation 590, the processor 320 may determine to hold the energy use or energy consumption when a supply price of each energy source over the energy consumption demand value is not profitable in an economical aspect.

In operations 560 and 580, when supply cost using the gas energy source among the plurality of energy sources is low, the processor 320 may control the energy consumption apparatus 330 to be supplied with the energy through the heat source for gas 337. Also, when supply cost using the electric energy source among the plurality of energy sources is low, the processor 320 may control the energy consumption apparatus 330 to be supplied with the energy through the heat source for electricity 335.

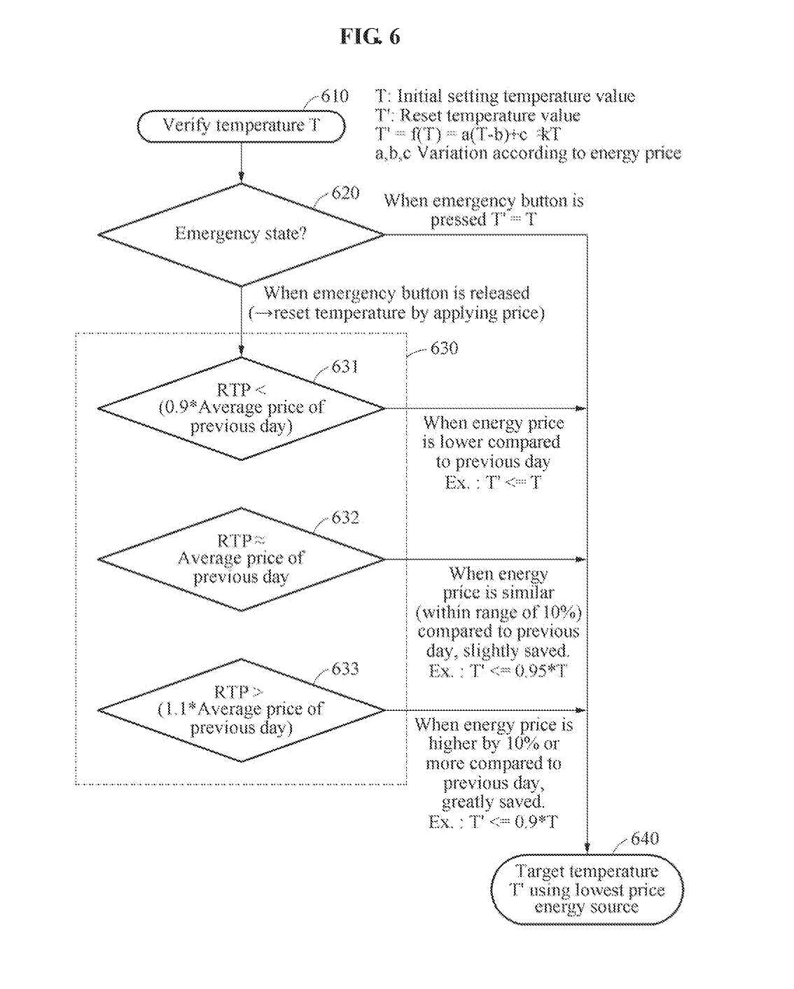

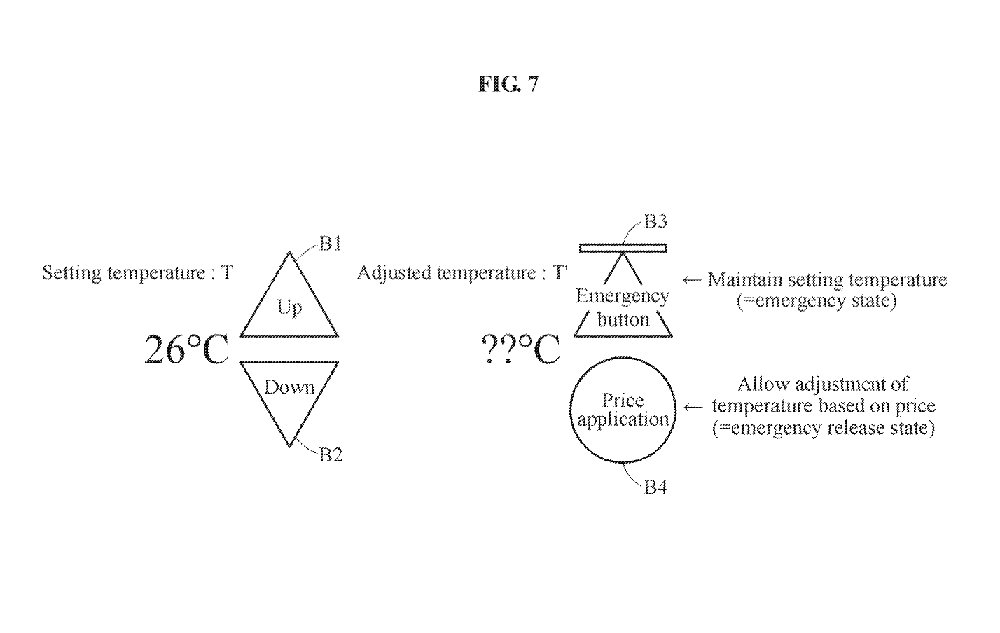

FIG. 6 is a flowchart illustrating an example of a method of selecting an energy source based on a result of evaluating an energy consumption demand value according to an example embodiment, and FIG. 7 illustrates an example of a user interface module of FIG. 3 according to an example embodiment.

In FIGS. 6 and 7, it is assumed that a level of a consumption need of a user for energy use is determined based on whether an energy use emergency button B3 of FIG. 7 is pressed or released, and adjustment of a setting temperature based on a price is determined based on whether a price application button B4 of FIG. 7 is pressed or released. The energy use emergency button B3 may correspond to the consumption need of the user for the energy use and the price application button B4 may correspond to a need of the user for adjusting the energy consumption demand for energy saving.

Referring to FIG. 7, the user interface module 311 may include buttons B1 and B2 for adjusting the setting temperature, the energy use emergency button B3, and the price application button B4.

In operation 610, the processor 320 may verify an initial setting temperature.

In operation 620, the processor 320 may determine the need of the consumption need of the user for the energy use based on whether the energy use emergency button B3 is pressed.

When the energy use emergency button B3 is pressed, the processor 320 may determine that the consumption need of the user for the energy use is to maintain the energy consumption demand. For example, the processor 320 may determine that the level of the consumption need of the user is “present” and/or “great”.

When the energy use emergency button B3 is pressed, the processor 320 may maintain the setting temperature and may determine a lowest price energy source in operation 640.

When the energy use emergency button B3 is released and the price application button B4 is pressed or not pressed, the processor 320 may determine that the consumption need of the user for the energy use is to adjust the energy consumption demand for energy saving in operation 630. For example, the processor 320 may determine that the level of the consumption need of the user is “absent” and/or “small”.

To adjust the energy consumption need for energy saving, the processor 320 may reset the initial setting temperature to save the energy in operations 631, 633, and 635. Here, the processor 320 may reset the setting temperature by applying a difference between an average energy price of a previous day and a real-time price (RTP) included in energy price information. For example, when the RTP is lower than the average energy price of the previous day, the setting temperature may be maintained as is in operation 631. On the contrary, when the RTP is similar to or higher than the average energy price of the previous day, the setting temperature may be adjusted based on a weight k in operations 633 and 635.

The weight k may be determined or set based on at least one of a number of times the energy use emergency button B3 is pressed or released and feedback of the user, for example, comments after use. For example, when the energy use emergency button B3 and/or the price application button B4 are frequently pressed or released, the weight k may be determined to be low to gradually increase a width applied for energy saving or cost saving. A pattern that the energy use emergency button B3 and/or the price application button B4 are pressed and the feedback of the user may be learned through deep-learning and applied to the weight k.

When the energy use emergency button B3 is released and the price application button B4 is pressed, the processor 320 may determine the lowest price energy source and may control the energy consumption apparatus 330 based on the reset temperature. Through this, energy saving effect corresponding to a difference between the initial setting temperature and the reset temperature may be achieved.

As described above, the example embodiments may provide a communication function to each apparatus and may receive price information through communication with a central information supporting apparatus present at a remote location before using energy. A consumer may select and use lowest price energy based on the provided energy price information.

The example embodiments may be applicable to various types of energy sources without being limited to gas or electricity, and may be applicable to various types of energy consuming devices without being limited to an energy consumption apparatus with a function of “heat source for gas and electricity”.

The example embodiments may minimize energy cost by applying a unit price of electricity showing a great variation for each time zone in real time. Compared to a current scheme, for example, an offline scheme, of predicting a price by setting a section based on a unit of 15 minutes, the example embodiments may transfer a price online in real time corresponding to a unit of a few seconds and may minimize energy cost accordingly.

The components described in the example embodiments may be achieved by hardware components including at least one DSP (Digital Signal Processor), a processor, a controller, an ASIC (Application Specific Integrated Circuit), a programmable logic element such as an FPGA (Field Programmable Gate Array), other electronic devices, and combinations thereof. At least some of the functions or the processes described in the example embodiments may be achieved by software, and the software may be recorded on a recording medium. The components, the functions, and the processes described in the example embodiments may be achieved by a combination of hardware and software.

The processing device described herein may be implemented using hardware components, software components, and/or a combination thereof. For example, the processing device and the component described herein may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

The software may include a computer program, a piece of code, an instruction, or some combination thereof, to independently or collectively instruct and/or configure the processing device to operate as desired, thereby transforming the processing device into a special purpose processor. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of controlling a demand management, the method comprising:
determining a lowest price energy source from among a plurality of energy sources based on energy price information associated with the plurality of energy sources and a level of a consumption need of a user for an energy use; and
controlling an energy consumption apparatus to be supplied with energy from the determined energy source and to consume the supplied energy.

2. The method of claim 1, further comprising:
acquiring the level of the consumption need of the user for the energy use in response to an energy consumption demand.

3. The method of claim 2, further comprising:
determining a current temperature and a setting temperature of the energy consumption apparatus, and determining whether the energy consumption demand occurs.

4. The method of claim 1, wherein the determining comprises:
evaluating an energy consumption demand value based on the consumption need of the user for the energy use in response to an energy consumption demand; and
selecting the energy source corresponding to the energy consumption demand value based on the energy price information.

5. The method of claim 4, wherein the selecting comprises:
maintaining an initial setting temperature of the energy consumption apparatus and selecting the lowest price energy source in response to the energy consumption demand value being evaluated to maintain the energy consumption demand; and
resetting the initial setting temperature and selecting the lowest price energy source in response to the energy consumption demand value being evaluated to adjust the energy consumption demand for energy saving.

6. The method of claim 5, wherein the resetting and the selecting comprises:
resetting the initial setting temperature by applying a difference between an average energy price of a previous day and a real-time energy price (RTP) included in the energy price information; and
selecting the lowest price energy source based on the reset temperature and the energy price information.

7. The method of claim 6, wherein the resetting and the selecting further comprises:
comparing the reset temperature and a current temperature of the energy consumption apparatus and holding the energy use.

8. The method of claim 6, wherein the resetting comprises setting a weight for resetting the initial setting temperature based on at least one of a number of times an energy use emergency button corresponding to the consumption need of the user is pressed and feedback of the user.

9. A consumer energy apparatus comprising:
a demand management control apparatus configured to determine a lowest price energy source from among a plurality of energy sources based on energy price information associated with the plurality of energy sources and a level of a consumption need of a user for an energy use, and
an energy consumption apparatus configured to be supplied with energy from the determined energy source and to consume the supplied energy under control of the demand management control apparatus.

10. The consumer energy apparatus of claim 9, wherein the demand management apparatus comprises:
a communication module configured to receive the energy price information; and
a processor configured to evaluate an energy consumption demand value based on the consumption need of the user for the energy use in response to an energy consumption demand, and to select the energy source corresponding to the energy consumption demand value based on the energy price information.

11. The consumer energy apparatus of claim 10, wherein the processor is configured to acquire the level of the consumption need of the user for the energy use in response to an energy consumption demand.

12. The consumer energy apparatus of claim 11, wherein the processor is configured to determine a current temperature and a setting temperature of the energy consumption apparatus, and to determine whether the energy consumption demand occurs.

13. The consumer energy apparatus of claim 10, wherein the processor is configured to:
maintain an initial setting temperature of the energy consumption apparatus and select the lowest price energy source in response to the energy consumption demand value being evaluated to maintain the energy consumption demand, and
reset the initial setting temperature and select the lowest price energy source in response to the energy consumption demand value being evaluated to adjust the energy consumption demand for energy saving.

14. The consumer energy apparatus of claim 13, wherein the processor is configured to:
reset the initial setting temperature by applying a difference between an average energy price of a previous day and a real-time energy price (RTP) included in the energy price information, and
select the lowest price energy source based on the reset temperature and the energy price information.

15. The consumer energy apparatus of claim 14, wherein the processor is configured to compare the reset temperature and a current temperature of the energy consumption apparatus and hold the energy use.

16. The consumer energy apparatus of claim 14, wherein the processor is configured to set a weight for resetting the initial setting temperature based on at least one of a number of times an energy use emergency button corresponding to the consumption need of the user is pressed and feedback of the user.

17. The consumer energy apparatus of claim 10, wherein the demand management control apparatus further comprises:
a user interface module configured to set a temperature of the energy consumption apparatus in response to an input of the user.

18. The consumer energy apparatus of claim 17, wherein the user interface module comprises an energy use emergency button corresponding to the consumption need of the user configured to maintain the energy consumption demand.

19. The consumer energy apparatus of claim 18, wherein the user interface module further comprises a price application button configured to corresponding to the consumption need of the user configured to adjust the energy consumption demand for energy saving.
